(19) United States
(12) Patent Application Publication
(10) Pub. No.: US 2020/0074397 A1
(43) Pub. Date: Mar. 5, 2020

(54) Asset Tracker

(71) Applicant: CalAmp Corp., Irvine, CA (US)

(72) Inventors: Brian J. Burda, Palos Verdes Estates, CA (US); Steve Burrington, Valley Center, CA (US); David B. Patton, Irvine, CA (US); James Hardee, Irvine, CA (US)

(73) Assignee: CalAmp Corp., Irvine, CA (US)

(21) Appl. No.: 16/559,330

(22) Filed: Sep. 3, 2019

Related U.S. Application Data
(60) Provisional application No. 62/736,535, filed on Sep. 26, 2018.
(60) Provisional application No. 62/725,942, filed on Aug. 31, 2018.

(51) Int. Cl. G06Q 10/08

(52) U.S. Cl. CPC G06Q 10/0833

(57) ABSTRACT

An asset tracker device includes a solar panel for powering a battery of the asset tracker device. The asset tracker device includes a modem for communicating a message regarding an asset to a remote server. The message includes a location of the asset and a status of the battery.

### CROSS-REFERENCE TO RELATED APPLICATIONS

This application claims priority to Provisional Application 62/725,942 entitled ASSET TRACKER and filed Aug. 31, 2018 and Provisional Application 62/736,535 entitled ASSET TRACKER and filed Sep. 26, 2018, which are incorporated herein by reference in their entirety.

### BACKGROUND

It is advantageous to track assets, such as shipping containers. Current asset trackers are battery powered or powered from a vehicle transporting the shipping container. However, vehicle power can be unreliable or unavailable. While battery powered asset tracking is advantageous, battery capacity limits can negatively affect the ability of the asset tracker to track assets.

### SUMMARY OF THE INVENTION

The present disclosure provides systems, methods, apparatuses, and computer readable products for tracking assets. In one embodiment, a modular asset tracker includes a main bracket for mounting the modular asset tracker to an asset; a solar panel coupled to the main bracket; a tracking unit having a tracking unit housing, wherein the tracking unit is disposed within the main bracket; a location sensor disposed within the tracking unit housing; a modem disposed within the tracking unit housing for communicating with a remote server; and a battery disposed within the tracking unit housing for powering the tracking unit, wherein the battery is electrically coupled to the solar panel for receiving power.

In an additional embodiment, the tracking unit includes: a processor; and memory comprising instructions that, when executed by the processor, cause the processor to: obtain a current location from the location sensor; and periodically transmit a message to the remote server, the message including the current location.

In another embodiment of the invention, the message further includes a battery voltage measurement usable to determine a capability of the solar panel to charge the battery.

In yet another additional embodiment, the solar panel is a 6.2 watt and 9.8 volt solar panel.

In yet another additional embodiment still of the invention, the main bracket is configured to angle the solar panel at least 40 degrees relative to a side of the asset when the main bracket is mounted to the side of the asset.

In still another embodiment of the invention, the asset is a corrugated shipping container; and the main bracket is configured to at least partially overlay at least three ridges of the corrugated shipping container when the modular asset tracker is mounted to the corrugated shipping container.

Still another embodiment of the invention includes, an integrated asset tracker including: a weather-resistant housing; a solar panel mounted to the weather-resistant housing; a location sensor disposed within the weather-resistant housing; a modem disposed within the weather-resistant housing for communicating with a remote server; and a battery disposed within the weather-resistant housing for powering the integrated asset tracker, wherein the battery is electrically coupled to the solar panel for receiving power.

In a further embodiment of the invention, the weather-resistant housing is configured to be mounted between ridges of a corrugated shipping container.

In yet another additional embodiment of the invention, the integrated asset tracker further includes: a processor disposed within the weather-resistant housing; and a memory disposed within the weather-resistant housing, where the memory includes instructions that, when executed by the processor, cause the processor to: obtain a current location from the location sensor; and periodically transmit a message to the remote server, the message including the current location.

In yet still another additional embodiment of the invention, the instructions further cause the processor to: obtain a movement sensor reading from a movement sensor; changing an operating mode of the integrated asset tracker from an active mode to a sleep mode responsive to determining that the movement sensor reading indicates a lack of movement; and changing the operating mode of the integrated asset tracker from the sleep mode to the active mode responsive to determining that the movement sensor reading indicates movement.

In still a further embodiment of the invention, the movement sensor is a GPS sensor or an accelerometer.

In a further embodiment of the invention, the integrated asset tracker is configured to charge the battery with the solar panel while the integrated asset tracker is operating in the sleep mode.

Still another embodiment of the invention includes an asset tracker method, the method comprising, with a processor of an asset tracker: powering the asset tracker from a solar panel of the asset tracker; obtaining a current location of the asset tracker from a location sensor while powering the asset tracker from a battery of the asset tracker; transmitting a message to a remote server while powering the asset tracker from the battery of the asset tracker, the message including the current location; and responsive to transmitting the message, switching from powering the asset tracker from the battery to powering the asset tracker from the solar panel.

In still another further embodiment of the invention, the method further includes: obtaining a first reading from a movement sensor; changing an operating mode of the asset tracker from an active mode to a sleep mode responsive to determining that the first reading indicates a lack of movement; and while the asset tracker is operating in the sleep mode, charging a battery of the asset tracker.

In a further embodiment of the invention, the method further includes obtaining a second reading from the movement sensor; and changing the operating mode of the asset tracker from the sleep mode to the active mode responsive to determining that the second reading indicates movement.

In still a further embodiment of the invention, the method further includes transmitting the message includes transmitting the message at a messaging rate; and wherein the method further includes: determining an amount of solar energy being received at the asset tracker; and modifying the messaging rate based on the amount of solar energy.

In still a further embodiment of the invention, the method further includes obtaining a battery voltage reading of a battery of the asset tracker, wherein the message includes the battery voltage reading.

Still another embodiment of the invention includes an asset tracking system, including: an asset; an asset tracker mounted to the asset; and a server remote from the asset tracker configured to receive communications from the asset tracker regarding a location of the asset.

In still a further embodiment, the asset tracker is mounted to the asset via an adhesive.

Still another embodiment of the invention includes an asset tracker, including: a solar panel power source of the asset tracker; a battery power source of the asset tracker; a charging circuit that charges the battery using power received from the solar panel; a location sensor providing location information to a remote server; a cellular modem communicating with the remote server; a power management circuit comprising a memory storing information regarding when to enable at least one of a plurality of functional components based an amount of power being generated by the solar panel power source, wherein the plurality of functional components include the charging circuit, the location sensor, and the cellular modem; wherein the power management circuit determines a power being generated by the solar panel power source and based on the power, determines an operational state of at least one functional component.

In a further embodiment of the invention, the information stored in memory comprises information on a set of functional components that can be enabled for a plurality of different voltages in the range of voltages.

In still a further embodiment of the invention, the power management circuit determines that a power being generated by the solar panel source is above a threshold and enables at least one functional component in the plurality of functional components.

In a further embodiment of the invention still, the power management circuit determines that a power being generated by the solar panel source is below a threshold and disables at least one functional component in the plurality of functional components.

In yet another further embodiment, the power management circuit measures a power level being generated by the solar panel source and determines an operational state of a set of functional components using the information stored in memory that identifies the set of functional components that can be enabled for a particular power level.

In a still additional embodiment of the invention, the asset tracker is in a sleep mode of operation and the charging circuit is enabled.

In yet another additional embodiment of the invention, the power management circuit determines an operational state of at least one functional component based on a battery level of the battery.

### BRIEF DESCRIPTION OF THE DRAWINGS

The features and advantages of the present disclosure will become more apparent from the detailed description set forth below when taken in conjunction with the following drawings.

FIG. 1 illustrates an asset tracking system in accordance with an embodiment of the invention.

FIG. 2 illustrates a perspective view of a modular asset tracker in accordance with an embodiment of the invention.

FIG. 3 illustrates a front view of the modular asset tracker of FIG. 2 in accordance with an embodiment of the invention.

FIG. 4 illustrates a rear view of the modular asset tracker of FIG. 2 in accordance with an embodiment of the invention.

FIG. 5 illustrates a cutaway view of the modular asset tracker of FIG. 2 in accordance with an embodiment of the invention.

FIG. 6 illustrates an exploded view of the modular asset tracker of FIG. 2 in accordance with an embodiment of the invention.

FIG. 7 illustrates a front view of a solar panel in accordance with an embodiment of the invention.

FIG. 8 illustrates a rear view of the solar panel of FIG. 7 in accordance with an embodiment of the invention.

FIG. 9 illustrates an asset in accordance with an embodiment of the invention

FIG. 10 illustrates cross section views of various intermodal container ridges compared to modular asset tracker bracket fastener locations in accordance with an embodiment of the invention.

FIG. 11 illustrates the modular asset tracker coupled to an intermodal container in accordance with an embodiment of the invention.

FIG. 12 illustrates the modular asset tracker coupled to an intermodal container in accordance with an embodiment of the invention.

FIG. 13 illustrates a block circuit diagram in accordance with an embodiment of the invention.

FIG. 14 illustrates a computing device in accordance with an embodiment of the invention.

FIG. 15 illustrates a software architecture diagram in accordance with an embodiment of the invention.

FIG. 16 illustrates an asset tracking process in accordance with an embodiment of the invention.

FIG. 17 illustrates an operating mode of an asset tracker switchable to and from an active mode and a sleep mode in accordance with an embodiment of the invention.

FIG. 18 illustrates a power management process for an asset tracker in accordance with an embodiment of the invention.

FIG. 19 illustrates an asset tracker in accordance with an embodiment of the invention.

FIG. 20 illustrates a power management method for an asset tracker in accordance with an embodiment of the invention.

FIG. 21 illustrates a learning process for determining which functional blocks to enable based on a current voltage in accordance with an embodiment of the invention in accordance with an embodiment of the invention.

FIG. 22 illustrates an example table specifying which functional blocks may be enabled for a particular open-circuit voltage in accordance with an embodiment of the invention in accordance with an embodiment of the invention.

FIG. 23 illustrates a process of enabling functional blocks of a unit based on measured solar power in accordance with an embodiment of the invention in accordance with an embodiment of the invention.

### DETAILED DESCRIPTION

The example embodiments presented herein are directed to systems, methods, and non-transitory computer-readable medium products for tracking a physical asset. This is for convenience only, and is not intended to limit the application of the present invention. After reading the following description, it will be apparent to one skilled in the relevant art how to implement the following disclosure in alternative embodiments.

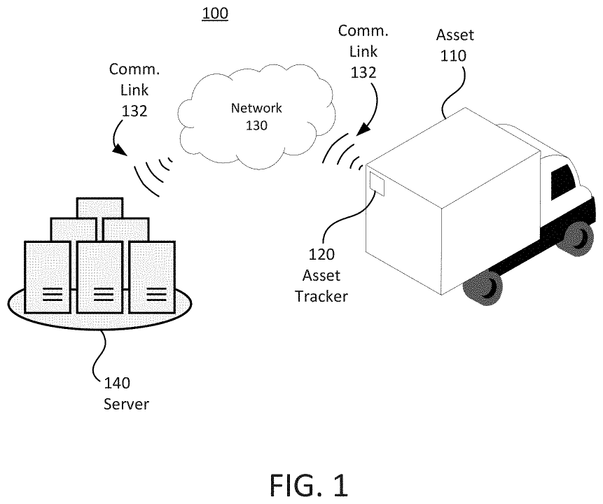

FIG. 1 illustrates an asset tracking system 100 in accordance with an embodiment of the invention. The asset tracking system 100 includes an asset tracker 110 coupled to an asset 120. The asset tracker 110 is communicatively coupled to a network 130 via a communication link 132. The asset tracker 110 is communicatively coupled to a server 140. The asset tracker 110 communicates asset tracking data to the server 140 via messages that include, among other data, a location of the asset tracker 110.

In an example, the asset 120 is a trailer, a container, a piece of construction equipment, a power generator, or other assets, especially those that are large and unpowered. The asset tracker 110 has various capabilities, such as: asset tracking, theft detection, accident detection, accident reconstruction, asset utilization, door open detection, door close detection, temperature monitoring, refrigeration monitoring, refrigeration control, tire pressure monitoring, load sensing (e.g., volume and weight).

In examples, the asset tracker 110 provides active asset tracking (e.g., transmitting messages, such as multiple messages per hour). In an example, the asset tracker 110 has a 5-7 year service life. The asset tracker 110 may include one or more cellular radios, such as one or more LTE-M (Long Term Evolution for Machines) radios. In some examples, the asset tracker 110 includes advanced telematics components. In examples, the asset tracker 110 includes a module for obtaining data from a CAN (Controller Area Network) bus of a vehicle. In an example, the asset tracker 110 includes a serial data transmission port (e.g., an RS-232 port), a communications bus (e.g., a 1-Wire communication bus), and a wireless communications module (e.g., a BLUETOOTH LE transceiver). The asset tracker 110 can be coupled to the asset 120 in any of a variety of ways, such as with screws, bolts, or adhesives. In examples, the asset tracker 110 is sized to fit within a recess (e.g., a valley formed by corrugations of a shipping container) or on a ridge of a corrugated shipping container. In other examples, the asset tracker 110 straddles two or more ridges of a corrugated asset. In an example, the asset tracker 110 is fastenable to a top or side of the asset 120. The asset tracker 110 can have a housing that withstands harsh conditions, particularly those experienced by intermodal shipping containers during transit.

The asset tracker 110 can have one or more components, characteristics, or capabilities of the integrated asset trackers or modular asset trackers described herein.

### Modular Asset Tracker

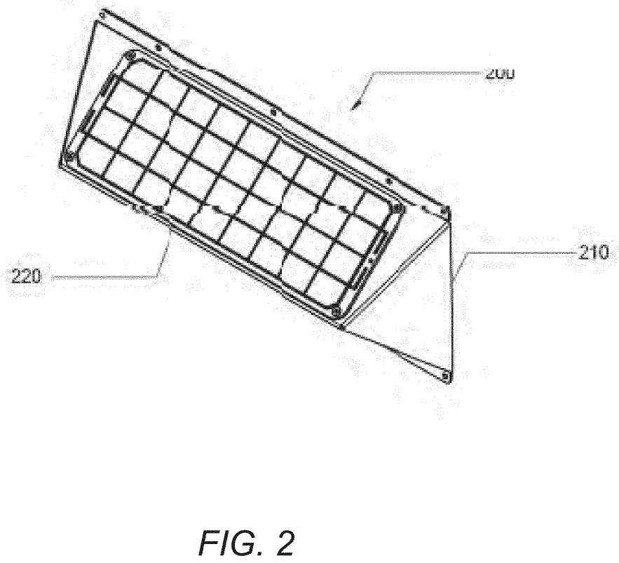

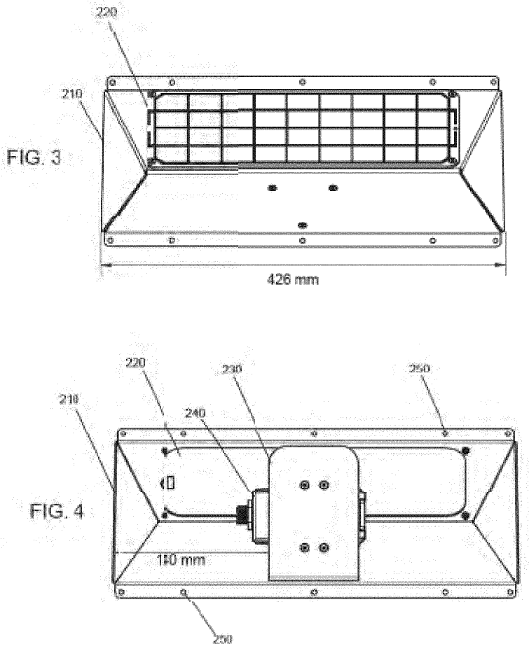

FIG. 2 illustrates a perspective view of a modular asset tracker 200 in accordance with an embodiment of the invention. The modular asset tracker 200 is modular in that is formed from several separate modules that can be readily and non-destructively separated or replaced. The primary modules of the illustrated modular asset tracker 200 are a main bracket 210 and a solar panel 220. Additional primary modules are an L-bracket 230 and a tracking unit 240, which are shown in later figures (see, e.g., FIG. 3). In some examples, there may be more or fewer primary modules.

The main bracket 210 is a primary housing of the modular asset tracker 200. The main bracket 210 defines a region where the solar panel 220 is mounted. In many examples, the surface is angled to improve the ability of the solar panel 220 to receive sunlight when the main bracket 210 is mounted to an asset. The main bracket 210 further defines a location where the L-bracket 230 and the tracking unit 240 are disposed. The main bracket 210 can form a complete or partial enclosure for the tracking unit 240 to resist the effects of weather on the tracking unit 240. In an example, the main bracket 210 is made from a material having a thickness of approximately 2 mm. In an example, the material is an anodized aluminum alloy, such as AL6063 or AL5052. In an example, the sides of the main bracket 210 are constructed from sheet metal flaps to shield internal components from weather.

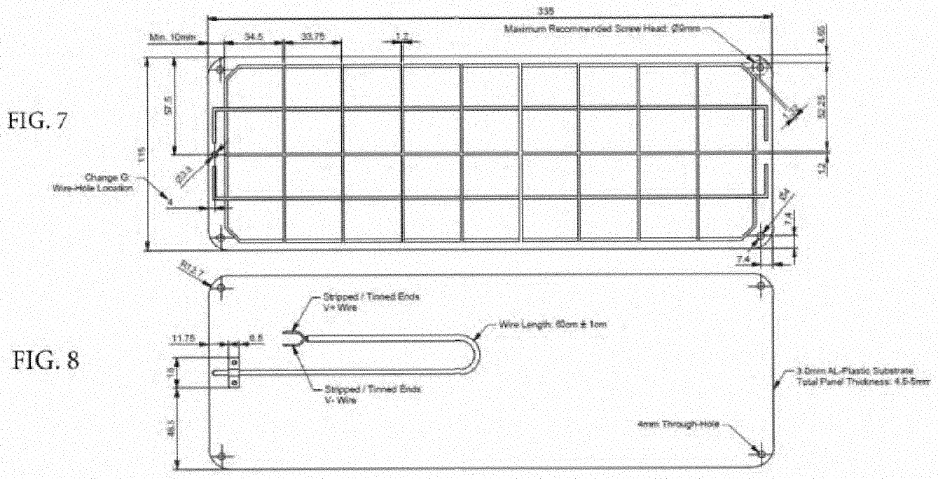

In many embodiments, the solar panel 220 is a module that converts solar energy (typically from sunlight, but in some instances solar thermal energy) into electrical energy to power other components of the modular asset tracker 200. In an example, the solar panel 220 charges a battery of the modular asset tracker 200, such as a battery of the tracking unit 240. This power from the solar panel 220 can allow the modular asset tracker 200 to be used with unpowered containers. In many examples, the solar panel 220 is removably mounted to the main bracket 210. In several embodiments, there is a protective exterior to the solar panel 220. The protective exterior can include one or more of: a wire mesh, a polymer film, or a glass sheet. An example implementation of a solar panel 220 in accordance with an embodiment of the invention is shown in FIG. 7 and FIG. 8. The size and characteristics of the solar panel 220 can be selected such that the solar panel 220 provides sufficient power to the components of the modular asset tracker 200 during a month of the year when a least amount of average sunlight is received and the solar panel 220 is optimally mounted. Generally, for a majority of the United States, over 1.6 hours of full sun can be expected even during the worst parts of winter. During the height of summer, the range is approximately 5.2-7.7 hours of full sun during a day. An insolation map showing a minimum number of hours of sunlight that an optimally-tilted solar panel would receive during a worst month of the year, and can be used to select an appropriate design for the solar panel 220.

Table I, below, illustrates example calculations usable to configure the modular asset tracker 200. In an example, the modular asset tracker has a configurable update time (e.g., the frequency at which the modular asset tracker transmits updates) based on device factors (e.g., battery capacity, load calculation, solar panel output, etc.). Below is a chart that shows example use case factors for configuring the device:

TABLE I

| | Update time | | | |
|---|---|---|---|---|
| | 1 | 5 | 30 | |
| | min. | min. | min. | |
| Battery capacity (5300 mAh, | 19.6 | 19.6 | 19.6 | Watt hours |
| 3.7 V) | | | | |
| Circuit consumption | 5.9 | 2.6 | 1.6 | Watt hours/day |
| Battery run time | 3 | 8 | 12 | Days |
| Required average daily battery | 6.4 | 2.8 | 1.8 | Watt hours/day |
| input | | | | |
| Required average daily input to | 7.2 | 3.2 | 2.0 | Watt hours/day |
| circuit | | | | |
| Hours per day charging at max rate | 2.2 | 1.0 | 0.6 | Hours/day |

Winter in Northern United States:

| | | |
|---|---|---|
| Flat output panel at 70° off | 3.2 | Watts |
| sun loss | | |
| Winter daily output | 7.0 | Watt hours/day |

Summer in Northern United States

| | | |
|---|---|---|
| Flat output panel at 25° off | 3.2 | Watts |
| sun loss | | |
| Summer daily output | 16.6 | Watt hours/day |

The battery capacity, circuit consumption, battery run time, required average daily input to battery, required average daily input to circuit, and hours per day charging at maximum rate are based on data from a CALAMP TTU2840 asset tracker unit. The hour per day charging at max rate is based on an assumption of 150K resistor maximum watts. The winter in northern United States data assumes average hours “full sun” winter. The summer in northern United States assumes average hours of full sun in summer for the northern United States. The summer daily output assumes average hours of full sun in the northern United States during the summer. In the United States, the summer range is approximately 5.2-7.7 hours per day. The battery run time is calculated as though the power usage were drawn from battery. The required average daily input to battery assumes a required 110% of capacity to charge. The required average daily input to circuit is based on average circuit efficiency including above and below optimal level. The hours per day of charging at a maximum rate assumes that the circuit accepts 3.2 watts into the circuit at maximum charge rate. The panel power specification per cell is 6.2 watts. The maximum power point of the panel (e.g., loss through construction, cutting cells, etc.) is 5.8 watts.

In an example, the configuration or assumptions can be validated using real-world or artificial testing. In an example, the estimated battery status (e.g., milliamp-hours available) over time between a maximum capacity and a minimum acceptable capacity line is plotted. The plot is then analyzed to determine whether the battery status is in an acceptable range between the maximum capacity and minimum acceptable capacity. If not, then modifications can be made and the analysis can be performed again.

FIG. 3 illustrates a front view of a modular asset tracker 200 of FIG. 2 in accordance with an embodiment of the invention. In the illustrated example, the modular asset tracker 200 includes one more fasteners that couple the main bracket 210 to an L-bracket 230 (not visible, see FIG. 4). The main bracket 210 includes one or more fasteners for coupling the modular asset tracker 200 to an asset. As illustrated, the main bracket 210 includes a plurality of screw holes having a diameter of 5 mm for coupling the modular asset tracker 200 to an asset. In the illustrated example, the width of the modular asset tracker 200 is approximately (e.g., within +/−0.1 mm) 426 mm.

FIG. 4 illustrates a rear view of the modular asset tracker 200 of FIG. 2 in accordance with an embodiment of the invention. The rear view shows the L-bracket 230. The L-bracket 230 is a module of the modular asset tracker 200 used to secure the tracking unit 240 to the main bracket 210. As illustrated, the L-bracket 230 is disposed approximately (e.g., within +/−0.1 mm) 140 mm from a lateral edge of the modular asset tracker 200 and has an overall width of approximately 146 mm. The modular asset tracker 200 includes one or more fasteners for coupling to the main bracket 210 and one or more fasteners for coupling to the tracking unit 240. In some examples, the L-bracket 230 is not “L” shaped and may instead take one or more other shapes. In such examples, the L-bracket can be referred to as a secondary bracket, though still may retain one or more characteristics of the L-bracket 230 described herein. In some examples the L-bracket 230 is integrated with (not separate from) the main bracket 210.

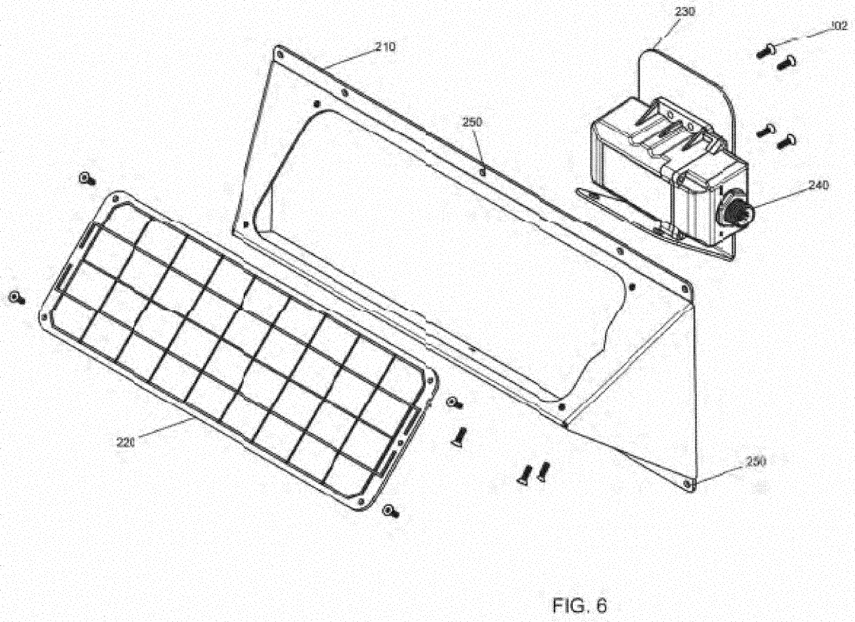

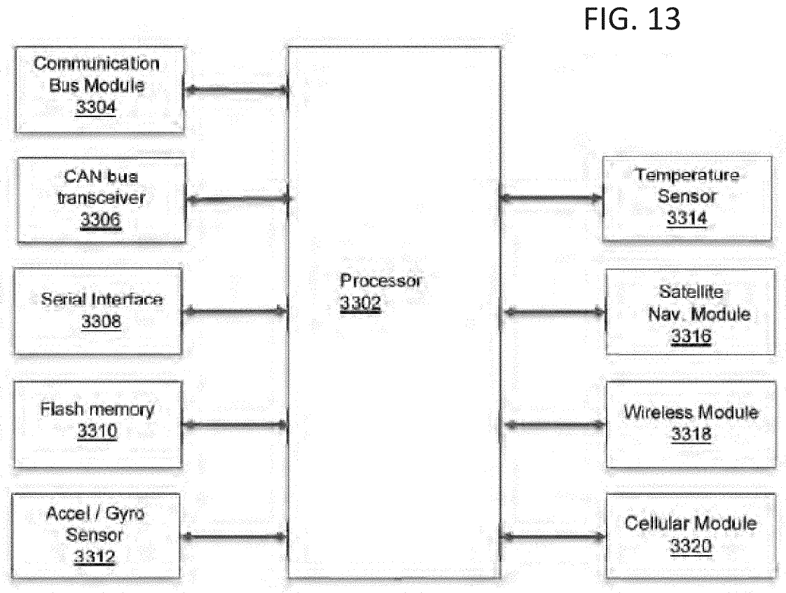

The tracking unit 240 is a module of the modular asset tracker 200 that obtains data. In many examples, the modular asset tracker 200 also transmits (e.g., using a cellular radio) the data near in time to when the data was obtained. The tracking unit 240 can take any of a variety of forms and can include one more components and features of the integrated asset tracker 1300 discussed below (see, e.g., FIG. 13). In an example, the tracking unit 240 is a CALAMP TTU-2840XTREME tracker (e.g., the TTU-280XTREME LTE SERIES or the TTU-280XTREME HSPA SERIES, the data sheets of which are provided as FIGS. 6B-6E of U.S. 62/725,942, which was previously incorporated by reference). In an example, the tracking unit 240 includes a rechargeable battery that is charged by the solar panel 220.

The modular asset tracker 200 further includes a plurality of attachment features 250. As illustrated, the attachment features 250 are holes through which screws, bolts, or other fasteners can pass to secure the modular asset tracker 200 to an asset. In other examples, the modular asset tracker 200 can include alternative or additional attachment features 250, such as adhesive strips or magnetic elements, among others.

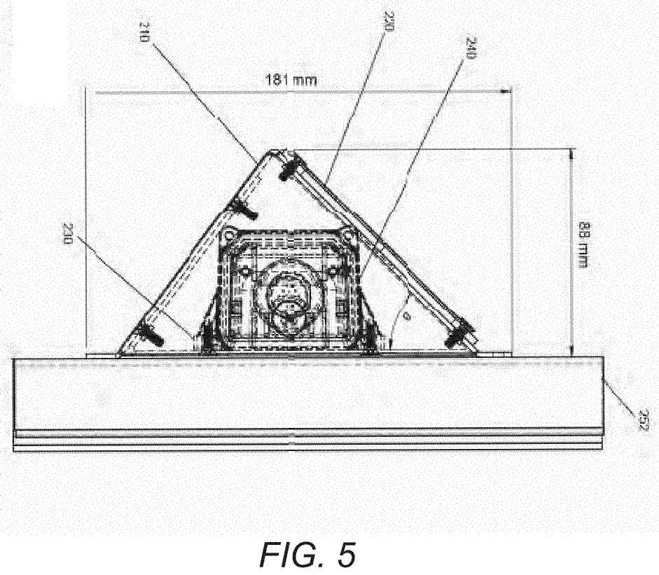

FIG. 5 illustrates a cutaway view of the modular asset tracker 200 of FIG. 2 attached to a side 262 of an asset in accordance with an embodiment of the invention. As illustrated, the main bracket 210 angles the solar panel 220 at an angle θ degrees relative to the side 252 of the asset to which the modular asset tracker 200 is mounted. As illustrated the angle θ is approximately 45 degrees, though other angles may be selected. In many examples, 45 degrees properly balances the amount that the main bracket 210 protrudes from the side 252 with the amount of angling of the solar panel 220 to collect sunlight. In an example, the main bracket 210 includes a component (e.g., knob) for manually adjusting the angle θ. In other examples, the main bracket 210 includes a motor to automatically adjust the angle θ. For instance, the angle θ may be automatically adjusted to allow the solar panel 220 to capture more sunlight than it would if the solar panel 220 were not adjusted, to enhance weather resistance (e.g., to resist snow or ice buildup on the solar panel 220), or to protrude less from the side 252.

FIG. 6 illustrates an exploded view of the modular asset tracker 200 of FIG. 2. As illustrated, there are screws 202 for securing one or more components together. In the illustrated example, there are four screws 202 for securing the tracking unit 240 to the L-bracket 230. In some examples, the L-bracket 230 and main bracket 210 include one or more fasteners, such as PEM brand fasteners from PENN ENGINEERING. In the illustrated example, there are four screws 202 for securing the solar panel 220 to the main bracket 210. In the illustrated example, there are there screws 202 for securing the L-bracket 230 to the main bracket 210. In an example, the main bracket 210 manufactured by stamping brackets from a single raw sheet. In an example, the main brackets 210 are stackable, thereby reducing shipping costs. In an example, the main bracket 210 provides a wide support to reduce vibration or bending.

FIG. 7 illustrates a front view of an example implementation of the solar panel 220 with example measurements in millimeters in accordance with an embodiment of the invention. FIG. 8 illustrates a rear view of the example implementation of the solar panel 220 of FIG. 7 with example measurements in millimeters in accordance with an embodiment of the invention. In the illustrated example, the solar panel 220 has a size of approximately (e.g., within +/0.1 mm) 335 mm×115 mm. In an example, the solar panel 220 is a 6.2 W and 9.8 V solar panel. In an example, the solar panel 220 is formed from a 3 mm aluminum alloy-plastic composite. In an example, the solar panel 220 has a urethane coating. In an example, the solar panel 220 is operable in a temperature range of approximately −40° C. to 85° C. In an example, the solar panel 220 has a 22 AWG wire that is 60 cm in length for electrically coupling the solar panel 220 to the tracking module 240. In an example, there is a metal strain relief. In an example, the solar panel 220 is an EE6E3C solar cell by EEPV CORP. In an example, the efficiency of the cell is 99.5%. In an example, the solar cell 220 has the characteristics described in TABLE II, below. Solar panels having other characteristics may be used.

TABLE II

| Attribute | Amount | Units |
|---|---|---|
| MC | 18 | Pieces |
| Open Current Voltage (Voc) | 11.50 | V |
| Maximum power voltage (Vp) | 9.75 | V |
| Short Circuit Current (Isc) | 0.68 | A |
| Maximum power current (Ip) | 0.64 | A |
| Watt peak (Wp) | 6.24 | W |

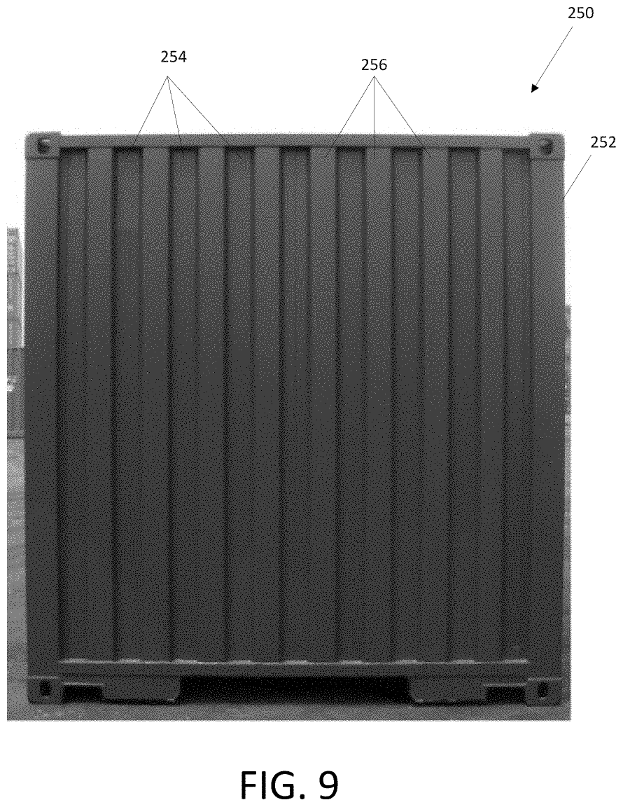

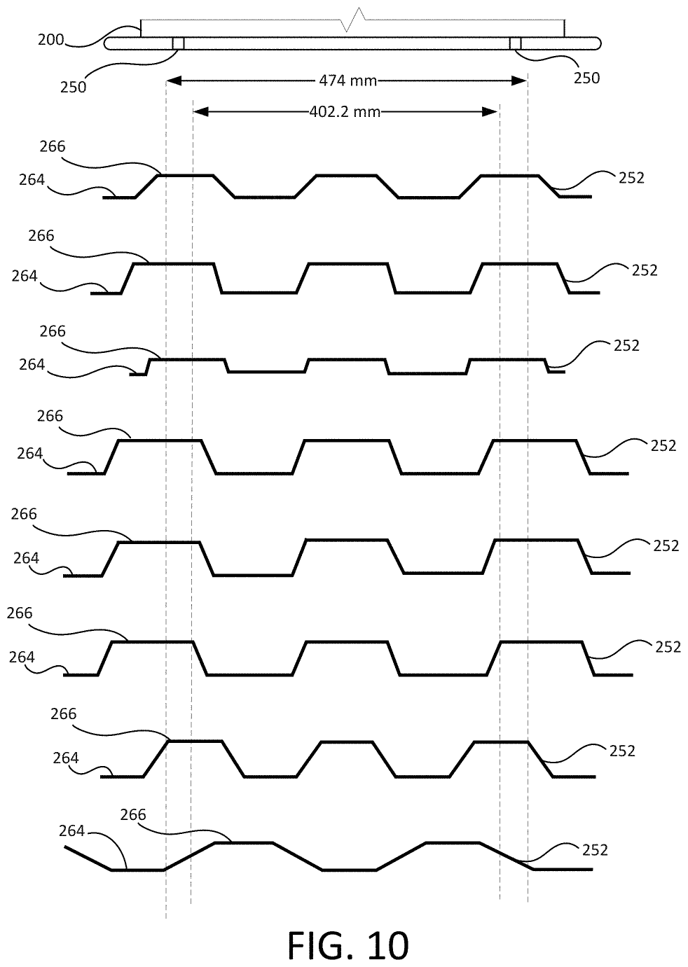

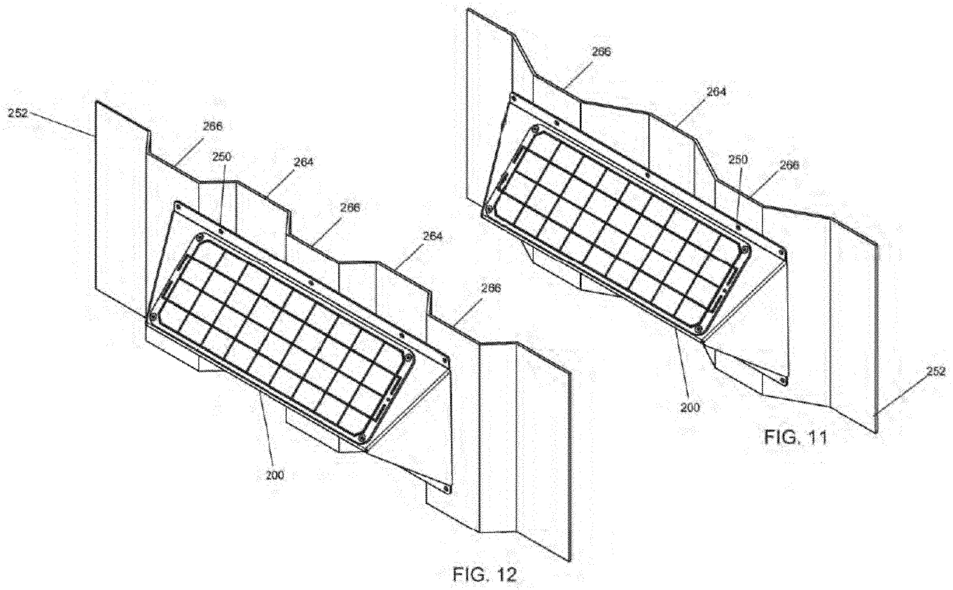

FIG. 9 illustrates the side 252 of an asset 260 in accordance with an embodiment of the invention. The asset 260 is an intermodal shipping container. The side 252 of the asset 260 corrugated to include a plurality of valleys 264 and a plurality of ridges 266. Where the modular asset tracker 200 is configured for use with such an asset 260, the attachment features 250 can be configured such that the modular asset tracker 200 can robustly attach to the corrugated side. In an example, the modular asset tracker 200 is attachable to one or more of the ridges 266 via the attachment features 250. Because the size and shape of the ridges 266 and valleys 264 formed by the corrugations of an asset are not universal, in many examples, the attachment features 250 disposed on the asset tracker 200 in a manner to be compatible with a wide variety of different corrugation configurations, such as is shown in FIG. 10. In an example, the modular asset tracker 200 is located near the top of the asset to not obscure trailer numbers or other indicia.

FIG. 10 illustrates cross section views of various sides 262 of assets 260 with valleys 264 and ridges 266. The figure further illustrates dashed lines showing an example range of locations of the attachment features 250 that would be compatible with ridges 266 of a wide variety of corrugation styles. In an example, the attachment features 250 are disposed on the modular asset tracker 200, in contact with one or more ridges 266. As illustrated, the attachment features 250 on the modular asset tracker 200 are spaced apart between approximately 402.2 mm and 474 mm to be compatible with a wide variety of corrugation styles.

FIG. 11 illustrates the modular asset tracker 200 coupled to ridges 266 of the side 252 of a corrugated asset. In the illustrated example, at least two attachment features 250 are located proximate a ridges 266 to allow the modular asset tracker 200 to be affixed to the corrugated asset. As illustrated, the main bracket 210 has a slight overhang beyond two ridges (e.g., approximately 39 mm of overhang on each side).

FIG. 12 illustrates the modular asset tracker 200 coupled to ridges of the side 252 of a corrugated asset. In the illustrated example, the main bracket 210 fully spans three ridges 266 on a container side wall.

### Integrated Asset Tracker

FIG. 13 illustrates a block circuit diagram of components of an integrated asset tracker in accordance with an embodiment of the invention. The block circuit diagram illustrates components that cooperate to provide one or more capabilities of the integrated asset tracker, including a processor 3302 (e.g., an STM32L496VG or STM32L4A6VG from STMICROELECTRONICS) a communication bus module 3304 (e.g., a 1-Wire communication bus module, such as a DS2484R+T from MAXIM INTEGRATED) connected to the processor over an I2C bus, a CAN bus transceiver 3306 (e.g., a CAN H/L MCP2562T-E/MF from MICROCHIP TECHNOLOGY INC.), a serial interface 3308 (e.g., a MAX3218EAP RS-232 interface from MAXIM INTEGRATED) with Universal Asynchronous Receiver-Transmitter (UART) support, flash memory 3310 (e.g., a W25Q16FWUXIE flash memory module from WINBOND ELECTRONICS) connected via a Serial Peripheral Interface (SPI), an accelerometer and gyroscopic sensor 3312 (e.g., an LSM6DSL chip from STMICROELECTRONICS) connected via SPI, a temperature sensor 3314 (e.g., a STTS751 temperature sensor by STMICROELECTRONICS) connected via SPI, a satellite navigation module 3316 (e.g., a UBX-M8030 from U-BLOX HOLDING AG) connected via UART, a wireless module 3318 (e.g., a BLUETOOTH wireless module, such as a BLUENRG-2 module from STMICROELECTRONICS) connected over UART, a cellular module 3320 (e.g., a BG96 module or EG91 module from QUECTEL WIRELESS SOLUTIONS CO.) connected via UART. Although FIG. 13 illustrates a particular circuit diagram of various components of an asset tracker, any of a variety of components may be specified as appropriate to the requirements of specific applications in accordance with embodiments of the invention.

### Computing Device

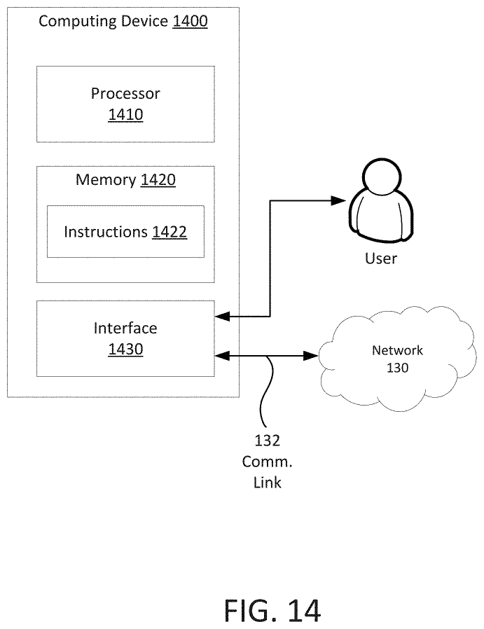

FIG. 14 illustrates a computing device with which one or more aspects herein can be implemented in accordance with an embodiment of the invention. One or more components described herein can be implemented as a computing device 1400 having a processor 1410 (e.g., a CPU), memory 1420 (e.g., transitory or non-transitory memory) storing instructions 1422 (e.g., instructions implementing one or more methods or operations described herein), an interface 1430 (e.g., for interfacing with a user or another device over the network 130 via a communication link 132). Although FIG. 14 illustrates a particular hardware architecture of a computing device of an asset tracker, any of a variety of architectures for the computing device may be utilized as appropriate to the requirements of specific applications in accordance with embodiments of the invention.

### Software Architecture

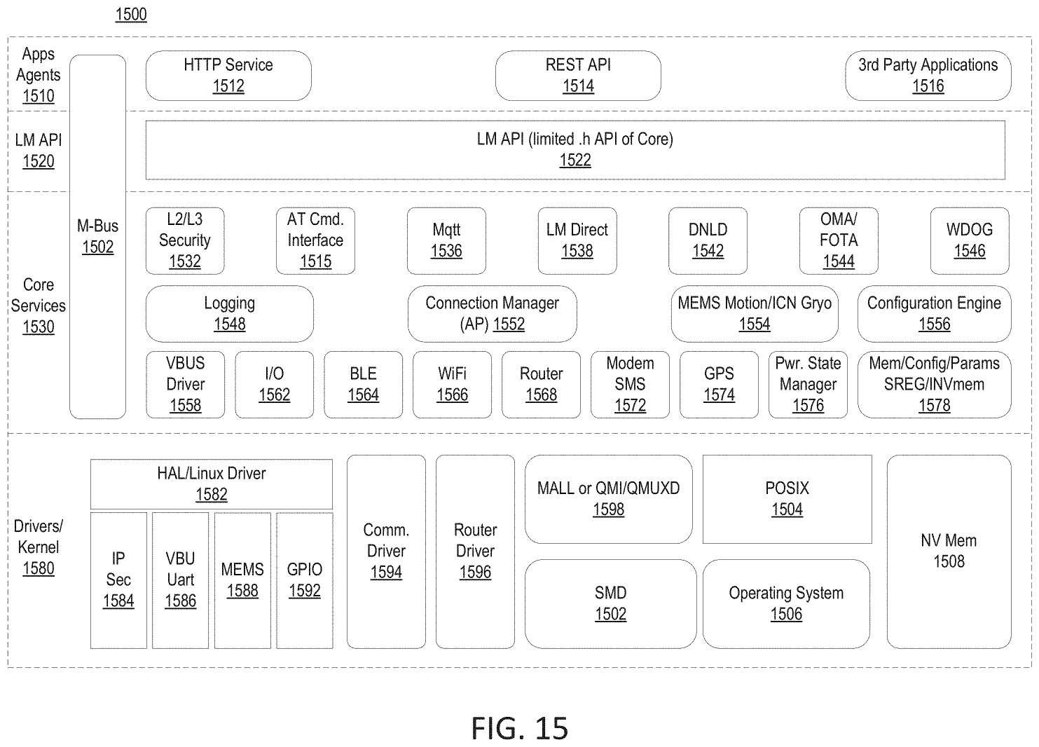

FIG. 15 illustrates a software architecture 1500 for use with asset trackers described herein in accordance with an embodiment of the invention. The software architecture 1500 is an example software architecture for providing one or more of the features and capabilities of the asset tracker. The software architecture 1500 includes a message bus 1502, an application/agent layer 1510, an LM API layer 1520, a core services layer 1530, and a driver/kernel layer 1580. The application/agent layer 1510 includes an HTTP service 1512, a REST API 1514, and 3rd party applications 1516. The LM API layer 1520 includes an LM API 1522 (e.g., a limited header API of the core services). The core services layer 1530 includes an L2/L3 security service 1532, an AT command interface service 1534, an MQTT (Message Queuing Telemetry Transport) service 1536, an LM direct service 1538, a DNLD service 1542, an OMA/FOTA service 1544, a WDOG service 1546, a logging service 1548, a connection manager service 1552, a MEMS motion/ICN Gyro service 1554, a configuration engine 1556, a VBUS driver 1558, an I/O service 1562, a BLUETOOTH LE service 1564, a WIFI service 1566, a router service 1568, a modem SMS service 1572, a GPS service 1574, a power state manager service 1576, and a memory/configuration/parameter SREG INVmem service 1578. The drivers/kernel layer 1580 includes a HAL (Hardware Abstraction Layer)/Linux driver, an IP sec module 1584, a VBU UART module 3486, a MEMS module 1588, a GPIO module 1592, communication drivers 1594 (e.g., drivers for HOSTAP, WIFI, or BLUETOOTH LE), a router driver 1596 (e.g., IPTABLES), MALL/QMI/QMUXD drivers 1598, SMD drivers 1502, a POSIX interface 1504, an operating system 1506 (e.g., a LINUX operating system or a real time operating system such as THREADX), and an NV memory module 1508. An asset tracker can use the configuration engine 1556 and one or more scripts to perform one or more asset tracking or power management operations. Although FIG. 15 illustrates a particular software architecture of a an asset tracker, any of a variety of software architectures for the asset tracker may be utilized as appropriate to the requirements of specific applications in accordance with embodiments of the invention.

### Asset Tracking Process

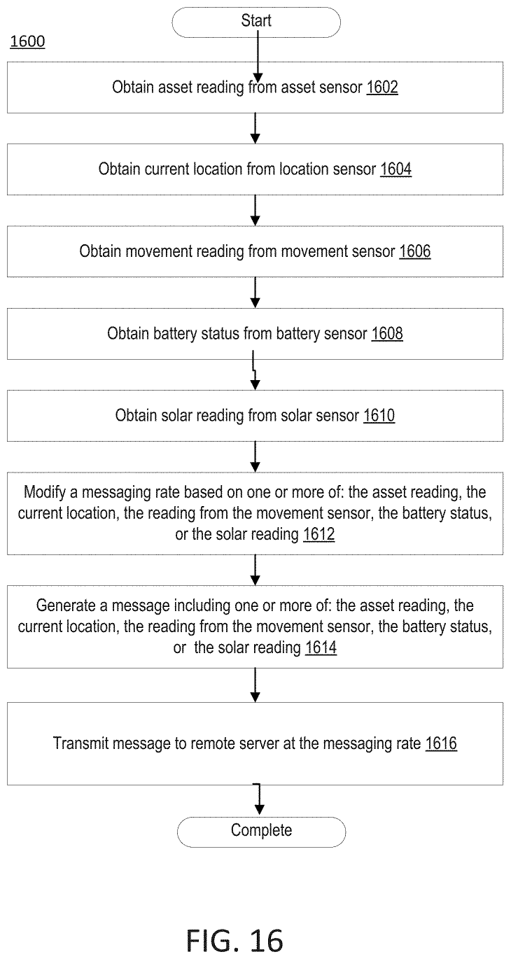

Various asset tracking processes can be used with the asset trackers described herein. In many examples, the asset tracker periodically obtains a location of the asset and transmits the location to a remote server. The frequency of obtaining and transmission of the location can vary based on whether the asset is moving (e.g., determined based on a movement sensor the asset tracker) or stationary. In an example, the asset tracker obtains and transmits a location (and other desired readings) once a day while the asset tracker is not moving. And when the asset tracker is moving, the asset tracker obtains and transmits a location (and other desired readings) once every fifteen minutes. A specific asset tracking process in accordance with an embodiment of the invention is shown in FIG. 16.

FIG. 16 illustrates an asset tracking process 1600 in accordance with an embodiment of the invention. The process 1600 includes operation 1602. Operation 1602 includes obtaining an asset reading from an asset sensor. In an example, obtaining the asset reading includes obtaining the asset reading from an asset sensor described herein, such as: obtaining a door control reading from a door control component, obtaining a temperature and humidity reading from a temperature and humidity sensor, obtaining a tire pressure reading from a tire pressure monitoring system, obtaining a load reading from a load sensor, obtaining a refrigeration reading from a refrigeration control, and obtaining an acceleration or gyroscopic reading from a accelerometer and gyroscopic sensor, among other readings from other sensors. In examples, obtaining the asset reading from the asset sensor includes obtaining a current reading from the asset sensor (e.g., activating the asset sensor, obtaining a reading, and then deactivating the asset sensor) or obtaining a recent reading from the asset sensor (e.g., the asset sensor obtains and stores readings, which are subsequently obtained as part of the operation 1602). In an example, obtaining the asset reading occurs at an asset reading frequency.

Operation 1604 includes obtaining a current location from a location sensor. In an example, obtaining the current location from the location sensor includes obtaining a location using one or more location determining components described herein. In an example, the operation 1604 includes: obtaining latitude and longitude from a satellite navigation module, obtaining a location based on nearby cell towers, or obtaining a location from an in-vehicle device (e.g., a navigation system of a vehicle carrying the asset). In examples, obtaining the location reading from the location sensor includes obtaining a current location from the location sensor or obtaining a recent reading stored by the location sensor. In an example, obtaining the current location occurs at a location reading frequency.

Operation 1606 includes obtaining a movement reading from a movement sensor. In an example, obtaining the movement reading from the movement sensor includes obtaining a movement reading from one or more components described herein. In an example, obtaining the movement reading includes: obtaining an acceleration or gyroscopic reading from a accelerometer and gyroscopic sensor, obtaining a speed from a satellite navigation module, obtaining a speed from a speedometer of a vehicle, obtaining a load reading from a load sensor, among others. In an example, obtaining the movement reading occurs at a movement reading frequency.

Operation 1608 includes obtaining a battery status from a battery status sensor. In an example, the operation 1608 includes obtaining a battery status from a battery status sensor described herein. In an example, obtaining the battery status includes obtaining a voltage of battery or obtaining an estimate of battery life of the battery. In an example, obtaining the battery status occurs at a battery status reading frequency.

Operation 1610 includes obtaining a solar reading from a solar sensor. In an example, obtaining the solar reading occurs at a solar reading frequency. In an example, the solar reading is a voltage coming from the solar sensor. In another example, the solar reading is a reading from a light sensor that detects an amount of sunlight.

Operation 1612 includes modifying a messaging rate based on one or more of: the asset reading, the current location, the reading from the movement sensor, the battery status, or the solar reading. In an example, the messaging rate is increased based on the readings indicate activity. For instance, if the movement sensors indicate movement, then the messaging rate is increased. If the movement sensors indicate that the asset is not moving, then the messaging rate is decreased. In an example, the messaging rate is increased if the battery status indicates that the battery is fully charged and the messaging rate is decreased if the battery status indicates that the battery has a low charge. In an example, the messaging rate is increased if the solar reading indicates that there is a sufficiently high amount of sunlight and the messaging rate is decreased if the solar reading indicates that there is relatively little sunlight. The frequencies can be similarly modified. For instance, one or more of the asset reading frequency, the location reading frequency, the movement reading frequency, the battery status reading frequency, and the solar reading frequency can be increased or decreased based on the readings. For instance, when the asset is not moving, the frequencies can be decreased and when the asset is moving, the frequencies can be increased.

Operation 1614 includes generating a message including one or more of: the asset reading, the current location, the reading from the movement sensor, the battery status, or the solar reading.

Operation 1616 includes transmitting the message to a remote server based on the messaging rate. In many examples, the messaging rate is less than or equal to the frequencies such that the message includes readings from the sensors. In examples, transmitting the message includes activating a cellular connection over which to transmit the message. In an example, transmitting the message includes switching from solar power to battery power prior to the transmission to ensure a consistent enough power source to power the transmission of the message. Although a variety of asset tracking processes in accordance with embodiments of the invention are illustrated in FIG. 16, any of a variety of asset tracking processes for an asset tracker unit can be utilized in accordance with embodiments of the invention.

### Power Management

The asset trackers described herein can use power management techniques. In examples, it is advantageous to control how the asset tracker is powered during the asset tracking process. For instance, power from a solar panel of the asset tracker can be inconsistent, which can causes fluctuations in voltage that negatively affect performance of the asset tracker. For instance, processes that draw relatively large amounts of power, such as obtaining a location of the tracker (e.g., using a GPS sensor) or transmitting a location of the asset tracker can be negatively affected by such fluctuations. It can be advantageous to switch to powering the asset tracker from a battery source prior to performing processes that draw relatively large amounts of power. Then, once the processes are complete, the asset tracker switches back to being powered from the solar panel. In addition, it can be advantageous for an asset tracker to be operable in different modes that have different power requirements and functionality.

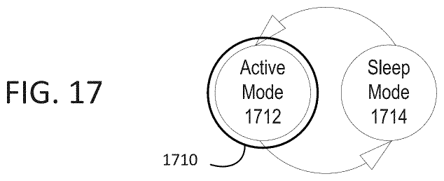

FIG. 17 illustrates an operating mode 1710 of an asset tracker switchable to and from an active mode 1712 and a sleep mode 1714 in accordance with an embodiment of the invention. In the sleep mode 1714, one or more features of the asset tracker may be disabled and the asset tracker may draw relatively less power. In some examples, while the operating mode 1710 is the sleep mode 1714, a process of the asset tracker operates at a relatively slower clock speed than during the active mode 1712. In some examples, the asset tracker operates using a low-power processor while the operating mode 1710 is the sleep mode 1714 compared to the operating mode 1710 being the active mode 1712 in which a relatively higher-powered processor is used. The asset tracker can operate using less power while the operating mode 1710 is the sleep mode 1714 compared to the operating mode 1710 being the active mode 1712. Although a variety of processes for switching modes of an asset tracker in accordance with embodiments of the invention are illustrated in FIG. 17, any of a variety of processes for switching modes can be utilized in accordance with embodiments of the invention.

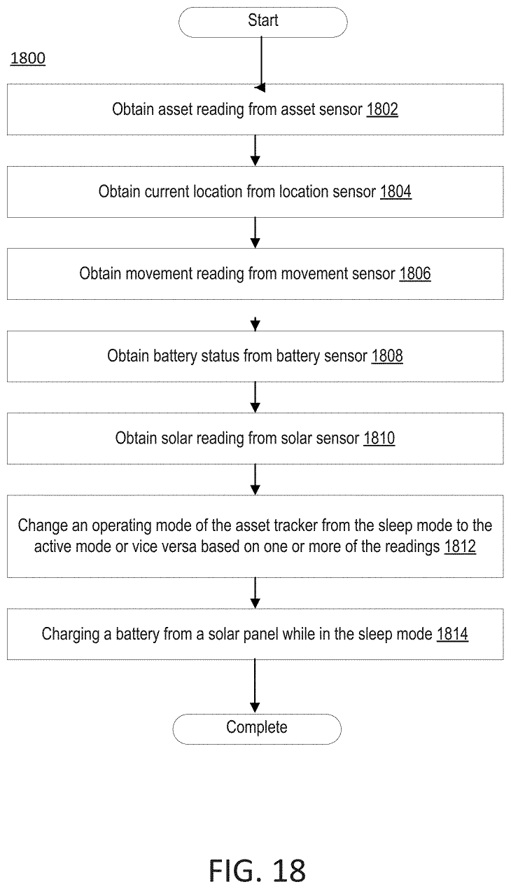

FIG. 18 illustrates a power management process 1800 for an asset tracker in accordance with an embodiment of the invention. As described in FIG. 17, the asset tracker can have an operating mode 1710 that is either an active mode 1712 or a sleep mode 1714. It can be advantageous to switch among the modes depending on various data obtained by the asset tracker.

The process 1800 includes operation 1802. Operation 1802 includes obtaining an asset reading from an asset sensor, such as described above in relation to operation 1602. Operation 1804 includes obtaining a current location from a location sensor, such as described above in relation to operation 1604. Operation 1806 includes obtaining a movement reading from a movement sensor, such as described above in relation to operation 1606. Operation 1808 includes obtaining a battery status from a battery sensor, such as described above in relation to operation 1608. Operation 1810 includes obtaining a solar reading from a solar sensor, such as described above in relation to operation 1610.

Operation 1812 includes changing an operating mode 1710 of the asset tracker from the sleep mode 1714 to the active mode 1712 or vice versa based on one or more of the readings obtained in one or more of operations 1802—#4010. For instance, if the data obtained in operations 1802-1810 indicate that the asset tracker is not moving or no events occur for a predetermined period of time, then the asset tracker can switch the operating mode 1710 to the sleep mode 1714 from the active mode 1712 or maintain the operating mode 1710 as being the sleep mode 1714. By contrast, if the data indicates that the asset tracker is moving or if an event occurs, then the asset tracker can switch the operating mode 1710 to the active mode 1712 from the sleep mode 1714 or maintain the operating mode 1710 as being the active mode 1712. The kinds of events or reading trigger a change can be customized by an administrator or manufacturer of the asset tracker. In some examples, the customization can be performed remotely.

Operation 1814 includes charging a battery from a solar panel while the operating mode 1710 of the asset tracker is the sleep mode 1714.

Although a variety of power management processes in accordance with embodiments of the invention are illustrated in FIG. 17, any of a variety of power management processes for an asset tracker unit can be utilized in accordance with embodiments of the invention.

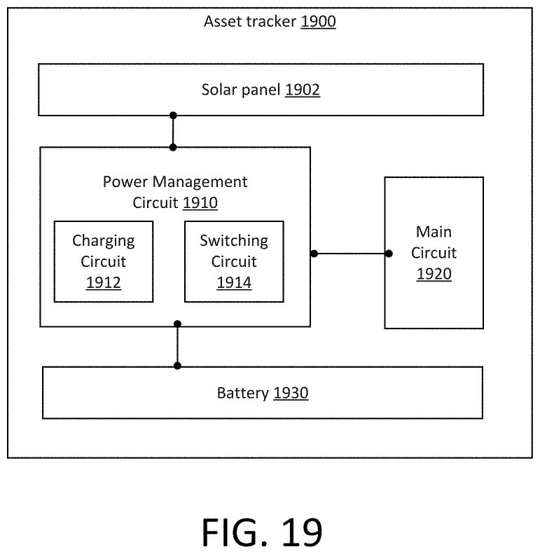

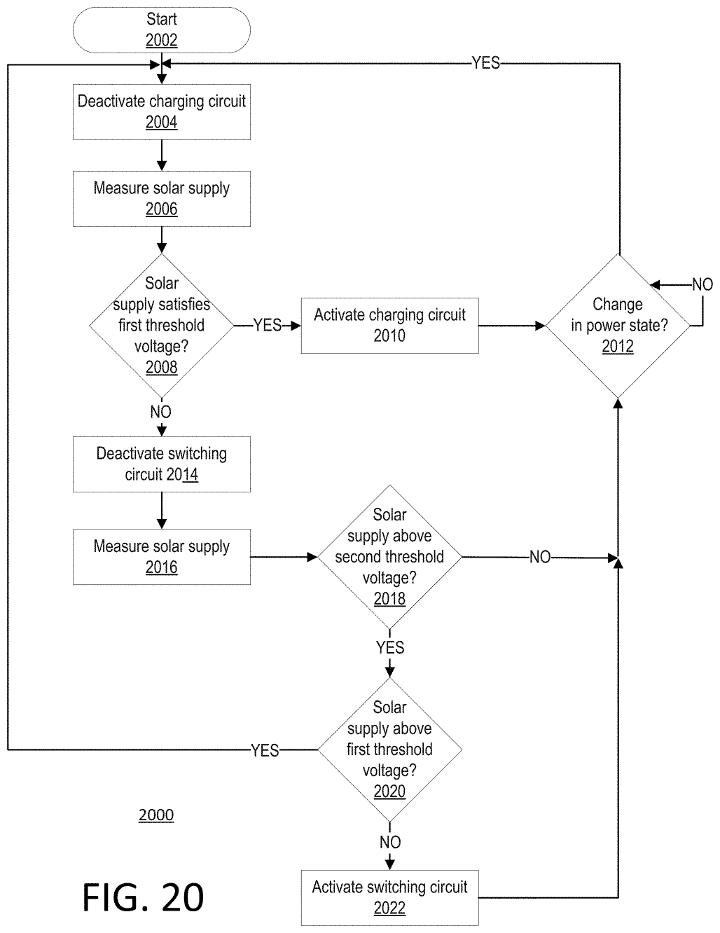

Asset trackers can include a power management circuit that manages the flow of power among the solar panel, battery, and main circuit of the asset tracker. An example circuit and management method are shown in FIG. 19 and FIG. 20, respectively in accordance with an embodiment of the invention.

FIG. 19 illustrates an asset tracker 1900 in accordance with an embodiment of the invention. The asset tracker includes a solar panel 1902, a power management circuit 1910, a main circuit 1920, and a battery 1930. The power management circuit 1910 is a one or more circuits of the asset tracker 1900 that manage power flow within the asset tracker 1900. The power management circuit 1910 includes a charging circuit 1912 and a switching circuit 1914. The solar panel 1902 is a module that converts solar energy into electrical energy to power other components of the asset tracker 1900 (e.g., as described elsewhere herein). The main circuit 1920 is a component of the asset tracker 1900 that draws power to perform one or more asset tracking functions, such as obtaining a location of the asset tracker and transmitting a message that includes the location. The battery 1930 is a component that can receive, store, and provide energy. The charging circuit 1912 is electrically coupled to the solar panel 4102 and the battery 1930. The charging circuit 1912 manages charging of the battery 1930 from the solar panel 1902. In examples, the charging circuit 1912 is also electrically coupled to the main circuit 1920 and can provide power to the main circuit 1920 while charging the battery 1930. The switching circuit 1914 is electrically coupled to the solar panel 1902, the main circuit 1920, and the battery 1930. The switching circuit 1914 controls from which power source the main circuit 1920 draws power: the solar panel 1902 or the battery 1930. When the switching circuit 1914 is deactivated, the main circuit 1920 is powered from the battery 1930. When the switching circuit 1914 is inactive, the main circuit 1920 is powered from the solar panel 1902. In examples, the power management circuit 1910, the charging circuit 1912, or the switching circuit 1914 include components that monitor the power coming from the solar panel 1902 or the battery 1930. In examples, the charging circuit 1912, and the switching circuit 1914 are controlled by hardware, software, or firmware components. For instance, the charging circuit 1912 can be controlled to charge the battery 1930 from the solar panel 1902 in some circumstances but not others. The switching circuit 1914 can be controlled to cause the main circuit 1920 to be powered from the battery 1930 or the solar panel 1902.

In an example power management process, the charging circuit 1912 is deactivated (e.g., preventing the battery 1930 from being charged by the solar panel 1902) solar supply voltage from the solar panel 1902 drops below a deactivation voltage threshold for a deactivation time threshold amount of time. In an example, the deactivation voltage threshold is a threshold that indicates that the solar panel 1902 cannot source enough current to charge the battery 1930. In an example, the deactivation voltage threshold is approximately 8.8 V and the deactivation time threshold is approximately 5 seconds. It can be advantageous to deactivate the charging circuit 1912 when the solar supply voltage is low because the charging circuit 1912 uses power to function. In an example, the charging circuit 1912 is not activated from the deactivated state unless the solar supply voltage exceeds an activation voltage threshold for an activation time threshold amount of time. In an example, the activation voltage threshold is 10.4 V and the activation time threshold is approximately 30 seconds. A further example is shown in FIG. 20. Although FIG. 19 illustrates a particular architecture of an asset tracker, any of a variety of architectures may be utilized as appropriate to the requirements of specific applications in accordance with embodiments of the invention.

FIG. 20 illustrates a power management method 2000 for an asset tracker in accordance with an embodiment of the invention. The method 2000 activates or deactivates the charging circuit 1912 and the switching circuit 1914 based on a solar supply from the solar panel 1902. The method 2000 begins at a start operation 2002. Following the start operation 2002, the flow moves to operation 2004.

In operation 2004, the charging circuit 1912 is deactivated and the flow moves to operation 2006. In operation 2006, the solar supply from the solar panel 1902 is measured. Measuring the solar supply includes measuring a voltage from the solar panel 1902. Next, the flow moves to operation 2008 in which it is determined whether the solar supply satisfies a first threshold voltage. In an example, the first threshold voltage is an amount of voltage that indicates that the solar panel 1902 can supply enough current to charge the battery 1930. In an example, the first threshold voltage is approximately 10.4 V and the first threshold voltage is satisfied if the solar supply voltage is greater than 10.4 V. In an example, the solar supply is monitored for a period of time and the first threshold voltage is satisfied if the voltage is greater than the first threshold voltage for the period of time (e.g., five seconds). If the solar supply satisfies the first threshold voltage, then the flow moves to operation 2010. If the solar supply threshold is not satisfied, then the flow moves to operation 2014. In operation 2010, the charging circuit 1912 is activated to charge the battery 1930 from the solar panel 1902. Then the flow moves to operation 2012.

In operation 2014, the switching circuit 1914 is deactivated. By deactivating the switching circuit 1914, the main circuit 1920 is powered from the battery 1930 rather than the solar panel 1902. The flow then moves to operation 2016 in which the solar supply is measured again. The flow then moves to operation 2018 where the solar supply is compared to a second threshold voltage. In an example, the second threshold voltage is a voltage that indicates that the main circuit 1920 is able to be powered by the solar panel 1902. For instance, the second threshold voltage may be 9.8 V. If the solar supply does not exceed the second threshold voltage, then the flow moves to operation 2012. If the solar supply does exceed the second threshold voltage, then the flow moves to operation 2020. In operation 2020, the solar supply is compared to the first threshold voltage as first described in operation 2008. Here, because the solar supply satisfied the second threshold voltage, the solar supply may be able to satisfy the first threshold voltage. If the solar supply satisfies the first threshold voltage, then the flow moves to operation 2002. If the solar supply does not satisfy the first threshold voltage, then the flow moves to operation 2022. In operation 2022, the switching circuit 1914 is activated such that the main circuit 1920 is powered from the solar panel 1902, and then the flow moves to operation 2012.

In operation 2012, a change in power state is monitored. For instance, the change in power state can be a change in voltage of the solar supply or from the battery 1930 that passes a threshold. In another example, a change in power state occurs if the asset tracker 1900 has operated in a particular power state for longer than a threshold amount of time. If a change in power state is detected, then the flow moves to operation 2002, otherwise the flow stays in operation 2012.

Although a variety of power management processes in accordance with embodiments of the invention are illustrated in FIG. 20, any of a variety of power management processes for an asset tracker unit can be utilized in accordance with embodiments of the invention.

In another method, the power management circuit 1910 implements a dynamic current charging circuit in which the battery 1930 is charged in a dynamically adjustable way, such that the battery 1930 is charged at an amount of energy that the solar panel 1902 can provide rather than at a fixed amount. For instance, if solar panel 1902 can source 550 mA, then the battery 1930 is charged at 550 mA. If the solar panel 1902 can source 300 mA, then the battery 1930 is charged at 300 mA. If the solar panel 1902 can source 100 mA, then the battery 1930 is charged at 100 mA. In this manner, the power management circuit 1910 adjusts charging rate of the battery 1930 to regulate the solar panel 1902 to 10.5V via a very slow control loop. This can allow charging of the battery 1930 under a variety of solar conditions.

### Solar Power Enhancements to Prolong Product Functionality

Many embodiments include an internal battery that can provide power to the asset tracker unit. Many embodiments may take advantage of a solar panel power source to charge the battery and/or power other features of the asset tracker unit. Many embodiments may only need enough power to keep the asset tracker unit running (e.g., enough power to power a low power microcontroller), which may or may not include charging a battery. Accordingly, many embodiments may learn, through testing or other mechanisms, the amount of power a solar panel is able to generate and provide under varying solar conditions. This knowledge may then be used to enable various functional components (e.g., battery charging circuit, cellular modem, satellite navigation such as GPS, among various others components) of the asset tracker unit based on how much power each unit needs to operate. This may allow for the use of the maximum number of hardware functions and components to be enabled for a given current solar conditions, without requiring any additional hardware or costs to provide this feature.

In particular, many embodiments seek to power a unit using only power from the sun as received through the solar panels. However this has many limitations. For example, the amount of solar energy available can be dependent on the type of solar panel used, the location, the time of day, direction of travel, weather conditions, among numerous other factors. In order to maximize the amount of operating time that an asset tracker unit can derive from the available solar energy, many embodiments incorporate additional intelligence and control mechanisms.

In many embodiments, an asset tracker unit may need at least a threshold number of volts to power the circuit board. Certain embodiments may need at least seven volts from the solar panel to power the circuit board and if the solar panel drops below seven volts, then the unit may be forced to run off the internal battery by turning off the switcher.

Accordingly, as long as the solar panel voltage is above the threshold number of volts (e.g., seven volts), the unit can take advantage of the solar energy to run as many functional hardware components (e.g., switching regulator, microcontroller, GPS, cellular Modem, battery charger, among various others) of the unit as possible. In certain embodiments, due to the firmware architecture, it is not always necessary that all functional hardware components be enabled. In certain embodiments, the components can include the switching regulator, microcontroller, GPS, cellular modem, and battery charger. Each of these functional components may consume a known amount of current. In certain embodiments, an important functional component is the microcontroller, which may consume a low current and so it may always be enabled. In certain embodiments, the microcontroller can be disabled by putting the unit to sleep.

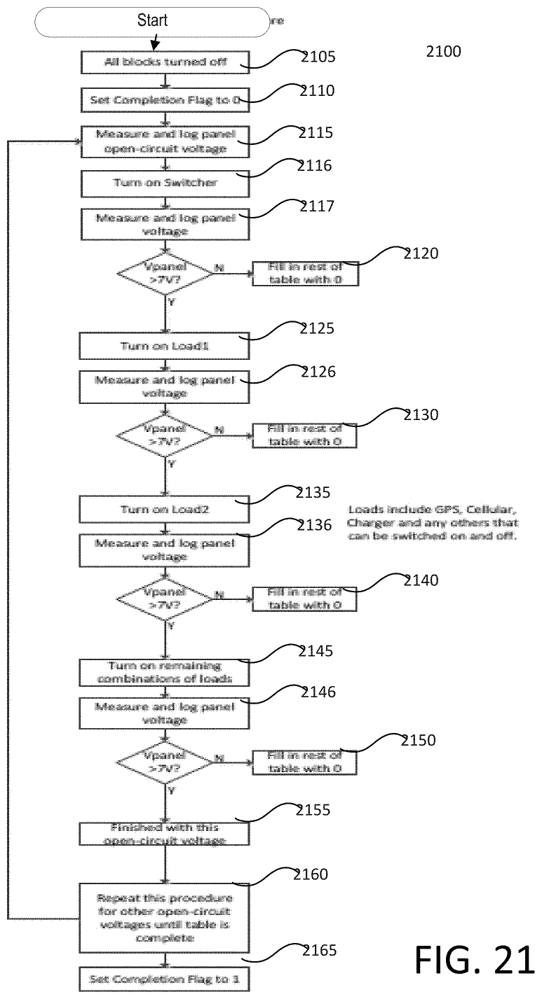

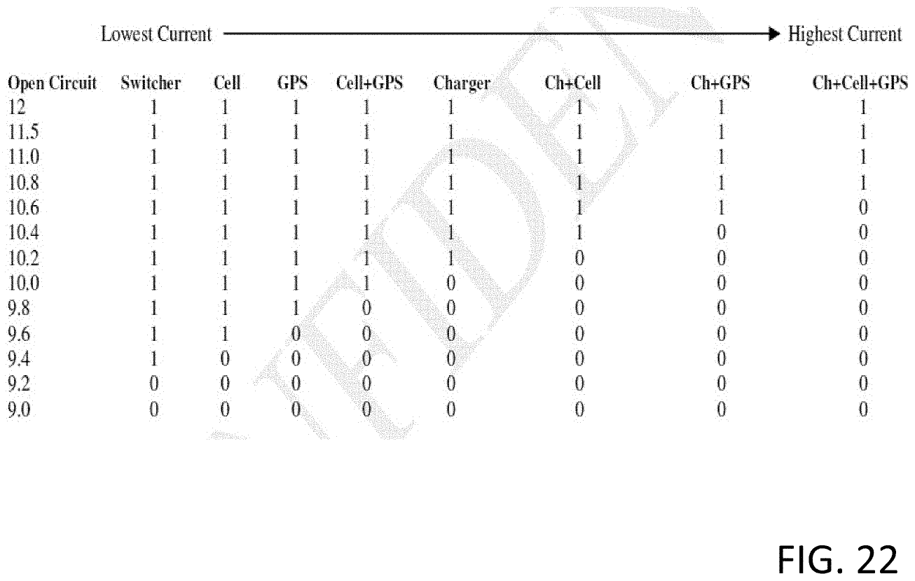

As such, based on the charger open-circuit voltage, the number of functional components that can be turned on can be determined while still maintaining an input voltage above the required threshold (e.g., seven volts). This may be a learning process as it can depend on the panel being used and the type of unit that the panel is being used on. Furthermore, the learning process may need to be adaptive. In certain embodiments, the learning process can be done during the manufacturing stage of the unit prior to the asset tracker unit being used by a user. A learning process for determining which functional components may be enabled based on a given voltage in accordance with an embodiment of the invention is illustrated in FIG. 21. An example table illustrating which functional components may be enabled for a particular open-circuit voltage in accordance with an embodiment of the invention is illustrated in FIG. 22. In some embodiments, the table can be created and stored in a memory (e.g., non-volatile memory or other) of an asset tracker unit.

As illustrated in FIG. 21, the process 2100 may start 2105 with all functional components (e.g., blocks) turned off. The process can set 2110 the completion flag to 0. The process may measure 2115 and log the panel open-circuit voltage. The process may turn on 2116 a functional component such as a switcher. In certain embodiments, the process may start with turning on the functional components and/or combinations of functional components that draws the lowest current to the highest current, as illustrated in, for example FIG. 22. In certain embodiments, the process can utilize other techniques for testing different components and combinations.

The process can measure 2117 and log the panel voltage. If the panel voltage is not above a threshold voltage (e.g., seven volts), the process fills 2120 the rest of a table, such as, for example, the table illustrated in FIG. 22, with ZEROS and returns to try a different open-circuit voltage until the table is complete.

If the panel voltage is above the threshold (e.g., seven volts), the process turns on 2125 a first load corresponding to a functional component (e.g., a load may include GPS, cellular modem, battery charger, among any of a variety of functional blocks that can be turned on or off) and measures and logs 2126 the panel voltage.

If the panel voltage is not above the threshold voltage (e.g., seven volts), the process fills 2130 the rest of the table, such as, for example, the table illustrated in FIG. 22 with ZEROS and returns to try a different open-circuit voltage until the table is complete. If the panel voltage is above the threshold (e.g., seven volts), the process turns on 2135 a second load and measures and logs 2136 the panel voltage.

If the panel voltage is not above the threshold voltage (e.g., seven volts), the process fills 2140 the rest of the table, such as, for example, the table illustrated in FIG. 22, with ZEROS and returns to try a different open-circuit voltage until the table is complete.

If the panel voltage is above the threshold (e.g., seven volts), the process turns on 2145 remaining combinations of loads and measures and logs 2146 the panel voltage. If the panel voltage is not above the threshold voltage (e.g., seven volts), the process fills 2150 the rest of the table, such as, for example, the table illustrated in FIG. 22, with ZEROS and returns to try a different open-circuit voltage until the table is complete.

If the panel voltage is above the threshold (e.g., seven volts), the process finishes 2155 with this open-circuit voltage and repeats 2160 this process for other open-circuit voltages until the table is complete. Once the table is complete, the process sets 2165 the completion flag to 1.

Although a variety of learning processes for determining which functional components can be enabled for a given open-circuit voltage in accordance with embodiments of the invention are illustrated in FIG. 21, any of a variety of learning processes for an asset tracker unit can be utilized in accordance with embodiments of the invention.

An example of using a learning process, such as the process illustrated in FIG. 21 described above, for an asset tracker unit having the following functional components, including GPS, cellular modem, and battery charger will now be described. The process may include determining the power consumed by different combinations of functional components, and may turn on additional functional components, or loads, from a lowest current load or combination to the highest current load. As illustrated in this example, the combinations going from lowest current to highest current proceed as follows: switcher, switcher+cellular, switcher+GPS, switcher+cellular+GPS, switcher+charger, switcher+charger+cellular, switcher+charger+GPS, and switcher+cellular+GPS. Accordingly, although FIG. 22 illustrates an example of testing different loads and combinations of loads for four functional components (switcher, cellular modem, GPS, and battery charger), the learning process could be adapted for any number of functional components and the different power/current requirements of the components as required for specific applications in accordance with embodiments of the invention.

An example of a learning process for an asset tracker that includes a switcher, cellular modem, GPS, and battery charger will now be described. As illustrated in the table in FIG. 22, for example, the process may start with the GPS, cellular modem, and charger turned off. The process may then measure the panel open-circuit voltage by turning off the switcher. This voltage is then logged as the open-circuit voltage. In certain embodiments, the voltage may need to be above a certain threshold (e.g., 9 volts) to start the learning process.

Switcher—The process may turn on the switcher and measure and log the voltage. If the voltage is above a threshold number of volts (e.g., 7 volts), the process goes to the next step.

Switcher plus Cellular—The process may turn the cellular modem on, then measure and log the panel voltage. If it is above the threshold (e.g., 7 volts), the process goes on to the next step.

Switcher plus GPS—The process may turn cellular off and turn GPS on, then measure and log the panel voltage. If it is above the threshold (e.g., 7 volts), the process goes on to the next step.

Switcher plus Cellular plus GPS—The process may turn the cellular modem on, then measure and log the panel voltage. If it is above the threshold (e.g., 7 volts), the process goes on to the next step.

Switcher plus Charger—The process may turn the cellular modem and GPS off and turn the charger on, then measure and log the panel voltage. If it is above the threshold (e.g., 7 volts), the process goes on to the next step.

Switcher plus Charger plus Cellular—The process may turn the cellular modem on and measure and log the panel voltage. If it is above the threshold (e.g., 7 volts), the process goes on to the next step.

Switcher plus Charger plus GPS—The process may turn the cellular modem off and turn GPS on, then measure and log the panel voltage. If it is above the threshold (e.g., 7 volts), the process goes on to the next step.

Switcher plus Charger plus Cellular plus GPS—The process may turn the cellular modem on, then measure and log the panel voltage.

If at any time above the panel voltage drops below the threshold (e.g., 7 volts), the process enters ZERO for that test and enters ZERO for the remaining tests.

In many embodiments, the process is repeated for a range of open-circuit voltages such that a complete table can be filled in with open circuit voltages. In certain embodiments, the range of open-circuit voltages may be ranging from 9 volts up to and beyond 12 volts. In many embodiments, the granularity of the range may vary and can be finer as functional components begin to drop out. As noted above, an example of a table in accordance with an embodiment of the invention is illustrated in FIG. 22. Although FIG. 22 illustrates storing the values within a table, any of a variety of data structures and formats may be utilized to specify which functional components may be enabled/disabled for a particular voltage level as appropriate to the requirements of specific applications in accordance with embodiments of the invention.

In certain embodiments, once a table has been created and stored in the non-volatile memory of an asset tracker unit, it may be used as follows:

1) When the unit is first turned on, enable the switcher and confirm that the internal battery voltage is above a certain threshold (e.g., 3.6 volts), if not, wait until it is above this threshold.

2) Disable the switcher and measure the open-circuit voltage.

3) Look in the table for an open-circuit voltage near the measured voltage. Use the row just below the measured voltage, where the items in that row with a ONE can now be turned on.

4) Periodically go back to step 2 in case the open-circuit voltage has increased and more blocks can be turned on.

5) Monitor the power-state signal for a change from ZERO to ONE. This may indicate that the input voltage has dropped too low for the load.

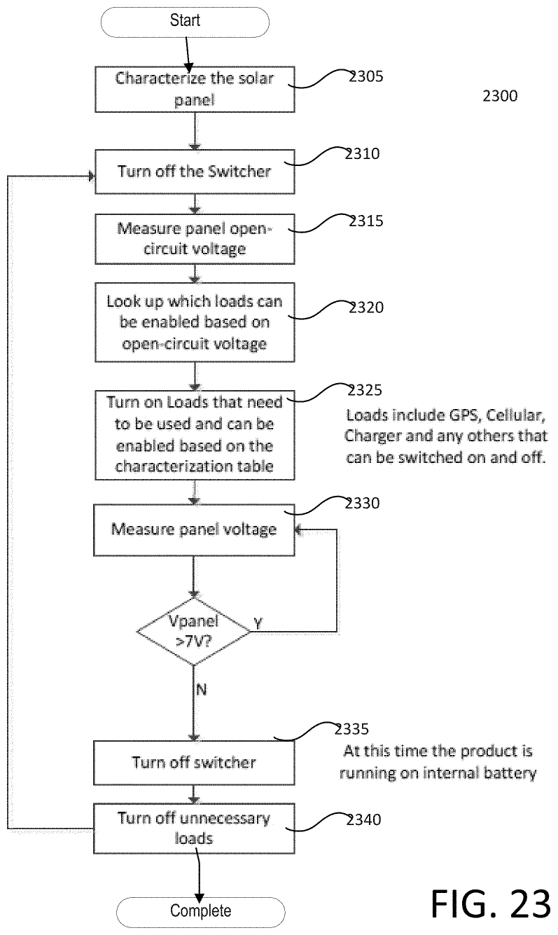

As described above, many embodiments may utilize a table to determine which, if any, functional components of an asset tracker unit to enable based on a measured amount of power available from a solar panel, as given by an open-circuit voltage reading. A power management process of enabling functional components of an asset tracker unit based on measured solar power in accordance with an embodiment of the invention is illustrated in FIG. 23. The process may characterize 2305 the solar panel. The process may turn off 2310 a switcher of the unit. The process measures 2315 panel open-circuit voltage. The process looks up 2320 which loads (e.g., functional components) can be enabled based on the open-circuit voltage. The process turns on 2325 loads that need to be used and that can be enabled based on the characterization table. The process measures 2330 the panel voltage. If the panel voltage is above a threshold, the process returns to measure the panel voltage. If the panel voltage is below a threshold, the process turns off 2335 the switcher (e.g., the asset tracker unit is now running on internal battery). The process turns off 2340 unnecessary loads. The process then completes. Although a variety of determining which functional components of an asset tracker unit can be enabled for a given voltage processes in accordance with embodiments of the invention are illustrated in FIG. 23, any of a variety of enabling processes can be utilized as appropriate to the requirements of specific applications in accordance with embodiments of the invention. Different modes of an asset tracker unit in accordance with embodiments of the invention are described below.

### Awake Mode

A learning process described above may be used to enable as many functional components of an asset tracker as possible under varying solar conditions. In many embodiments, restrictions on what may be turned on may also be based on the battery voltage. In certain embodiments, if the battery is fully charged, then there may be no or minimal harm in enabling all or most of the functional components of an asset tracker unit. However, if the battery is getting low, even though the solar panel may be receiving sufficient solar energy from the sun at a particular moment, certain embodiments may choose to limit what other functional components are turned on based on a particular priority of the components in order to allow the battery to get charged in view that the solar conditions may deteriorate in the future. Accordingly, certain embodiments may set a battery charger component of the asset tracker as a highest priority and thus should be enabled when there is sufficient solar power. In certain embodiments, a cellular modem and satellite navigation such as GPS may be left off most of the time and only turned on when needed based on the particular use case. Certain embodiments may also throttle down the rate at which an asset tracker unit sends messages as a function of the rate at which the battery charge is reduced or as the amount of solar energy is reduced. Accordingly, many embodiments may enable and disable functional components based on a variety of parameters, including a priority of a particular component, the current solar conditions, the current internal battery status, the use case of the asset tracker, among various other factors as appropriate to the requirements of specific applications in accordance with embodiments of the invention.

### Sleep Mode

In certain embodiments, a sleep mode can be a lowest power consuming mode of an asset tracker unit. In many embodiments, in sleep mode, the microcontroller may be stopped, and the GPS and cellular modem turned off. This mode may be intended to conserve power and prolong the life of the internal battery of the asset tracker. When the sun and the open-circuit voltage is below a threshold, the unit can run entirely off of the internal battery. Furthermore, in certain embodiments, it may be advantageous to spend as much time as possible sleeping for certain types of asset trackers and the processor can wake up occasionally to check the panel voltage to see if the sun has come up and solar energy is now available as a power source.

In several embodiments, if the product is in a sleep mode when there is abundant solar energy and the sun is abundant, an asset tracker may choose to enable or disable the battery charger based on the open-circuit panel voltage. In certain embodiments, if the asset tracker unit is to sleep with the battery charger enabled, certain embodiments can set up a change in the power state to wake a processor of the asset tracker so that it can make a determination as to whether the charger should remain on or be turned off given the change in power state.

While various example embodiments of the present invention have been described above, it should be understood that they have been presented by way of example, and not limitation. It will be apparent to persons skilled in the relevant art(s) that various changes in form and detail can be made therein. Thus, the present invention should not be limited by any of the above described example embodiments, but should be defined only in accordance with the following claims and their equivalents. Further, the Abstract is not intended to be limiting as to the scope of the example embodiments presented herein in any way. It is also to be understood that the procedures recited in the claims need not be performed in the order presented.

What is claimed is:

1. A modular asset tracker comprising:
a main bracket for mounting the modular asset tracker to an asset;
a solar panel coupled to the main bracket;
a tracking unit having a tracking unit housing, wherein the tracking unit is disposed within the main bracket;
a location sensor disposed within the tracking unit housing;
a modem disposed within the tracking unit housing for communicating with a remote server; and
a battery disposed within the tracking unit housing for powering the tracking unit, wherein the battery is electrically coupled to the solar panel for receiving power.

2. The modular asset tracker of claim 1,
wherein the solar panel is a 6.2 watt and 9.8 volt solar panel.

3. The modular asset tracker of claim 1,
wherein the main bracket is configured to angle the solar panel at least 40 degrees relative to a side of the asset when the main bracket is mounted to the side of the asset.

4. The modular asset tracker of claim 1,
wherein the asset is a corrugated shipping container; and
wherein the main bracket is configured to at least partially overlay at least three ridges of the corrugated shipping container when the modular asset tracker is mounted to the corrugated shipping container.

5. An integrated asset tracker comprising:
a weather-resistant housing;
a solar panel mounted to the weather-resistant housing;
a location sensor disposed within the weather-resistant housing;
a modem disposed within the weather-resistant housing for communicating with a remote server; and
a battery disposed within the weather-resistant housing for powering the integrated asset tracker,
wherein the battery is electrically coupled to the solar panel for receiving power.

6. The integrated asset tracker of claim 5,
wherein the weather-resistant housing is configured to be mounted between ridges of a corrugated shipping container.

7. The integrated asset tracker of claim 5, further comprising:
a processor disposed within the weather-resistant housing; and
a memory disposed within the weather-resistant housing,
wherein the memory comprises instructions that, when executed by the processor, cause the processor to:
obtain a current location from the location sensor; and
periodically transmit a message to the remote server, the message including the current location.

8. The integrated asset tracker of claim 7,
wherein the instructions further cause the processor to:
obtain a movement sensor reading from a movement sensor;
changing an operating mode of the integrated asset tracker from an active mode to a sleep mode responsive to determining that the movement sensor reading indicates a lack of movement; and
changing the operating mode of the integrated asset tracker from the sleep mode to the active mode responsive to determining that the movement sensor reading indicates movement.

9. The integrated asset tracker of claim 8,
wherein the movement sensor is a GPS sensor or an accelerometer.

10. The integrated asset tracker of claim 8,
wherein the integrated asset tracker is configured to charge the battery with the solar panel while the integrated asset tracker is operating in the sleep mode.

11. An asset tracker method, the method comprising, with a processor of an asset tracker:
powering the asset tracker from a solar panel of the asset tracker;
obtaining a current location of the asset tracker from a location sensor while powering the asset tracker from a battery of the asset tracker;
transmitting a message to a remote server while powering the asset tracker from the battery of the asset tracker, the message including the current location; and
responsive to transmitting the message, switching from powering the asset tracker from the battery to powering the asset tracker from the solar panel.

12. The asset tracker method of claim 11, further comprising:
obtaining a first reading from a movement sensor;
changing an operating mode of the asset tracker from an active mode to a sleep mode responsive to determining that the first reading indicates a lack of movement; and
while the asset tracker is operating in the sleep mode, charging a battery of the asset tracker.

13. The asset tracker method of claim 12, further comprising:
obtaining a second reading from the movement sensor; and
changing the operating mode of the asset tracker from the sleep mode to the active mode responsive to determining that the second reading indicates movement.

14. The asset tracker method of claim 11, wherein transmitting the message includes transmitting the message at a messaging rate; and
wherein the method further includes:
determining an amount of solar energy being received at the asset tracker; and
modifying the messaging rate based on the amount of solar energy.

15. The asset tracker method of claim 11, further comprising:
obtaining a battery voltage reading of a battery of the asset tracker,
wherein the message includes the battery voltage reading.

16. An asset tracking system, comprising:
an asset;
an asset tracker mounted to the asset; and
a server remote from the asset tracker configured to receive communications from the asset tracker regarding a location of the asset.

17. The asset tracking system of claim 16, wherein the asset tracker is mounted to the asset via an adhesive.

18. An asset tracker, comprising:
a solar panel power source of the asset tracker;
a battery power source of the asset tracker;
a charging circuit that charges the battery using power received from the solar panel;
a location sensor providing location information to a remote server;
a cellular modem communicating with the remote server;
a power management circuit comprising a memory storing information regarding when to enable at least one of a plurality of functional components based an amount of power being generated by the solar panel power source, wherein the plurality of functional components include the charging circuit, the location sensor, and the cellular modem;
wherein the power management circuit determines a power being generated by the solar panel power source and based on the power, determines an operational state of at least one functional component.

19. The asset tracker of claim 18, wherein the information stored in memory comprises information on a set of functional components that can be enabled for a plurality of different voltages in the range of voltages.

20. The asset tracker of claim 18, wherein the power management circuit determines that a power being generated by the solar panel source is above a threshold and enables at least one functional component in the plurality of functional components.

21. The asset tracker of claim 18, wherein the power management circuit determines that a power being generated by the solar panel source is below a threshold and disables at least one functional component in the plurality of functional components.

22. The asset tracker of claim 18, wherein the power management circuit measures a power level being generated by the solar panel source and determines an operational state of a set of functional components using the information stored in memory that identifies the set of functional components that can be enabled for a particular power level.

23. The asset tracker of claim 18, wherein the asset tracker is in a sleep mode of operation and the charging circuit is enabled.

24. The asset tracker of claim 18, wherein the power management circuit determines an operational state of at least one functional component based on a battery level of the battery.
